(19) United States
(12) Patent Application Publication
(10) Pub. No.: US 2016/0093185 A1
(43) Pub. Date: Mar. 31, 2016

(54) Mobile Security System and A Security Method of the Same

(71) Applicant: Smart Approach Co., Ltd., Hsinchu County (TW)

(72) Inventor: Hsin-Lung Lin, Hsinchu County (TW)

(21) Appl. No.: 14/594,210

(22) Filed: Jan. 12, 2015

(30) Foreign Application Priority Data
Sep. 29, 2014 (TW) 103133685

(51) Int. Cl. G08B 13/24

(52) U.S. Cl. CPC G08B 13/2451

(57) ABSTRACT

A mobile security system is configured to identify a commodity. The mobile security system includes a wireless induction tag and a mobile electronic device. The wireless inductive tag is adhered to the commodity. A code is saved in the wireless inductive tag, and the code is derived from information of the commodity via encryption. The mobile electronic device includes a NFC unit, an application program, and a display screen. The code of the wireless inductive tag is read by the application program via the NFC unit, and the code is deciphered by the application program. The information obtained from deciphering the code by the application program is displayed in the display screen.

### BACKGROUND OF THE INVENTION

1. Field of the Invention

The invention relates to a mobile security system, and more particularly relates to a mobile security system which uses NFC (Near Field Communication) or Bluetooth communication function built in a mobile electronic device.

2. Description of the Prior Art

In general, commodities in the market become more diverse. Whether livelihood commodities or luxurious commodities, they all can create considerable profit. However, the considerable profit also attracts some unworthy vendor. They profiteer enormously by selling fake commodities, and finally, consumers always become victims.

Some companies use the security label to identify the commodity and protect consumers. However, the most currently used security labels use the RFID technology. Those RFID security labels only can be read by a special sensing device, and most consumers don't have such special sensing device. Therefore, consumers only can trust the determining results obtained from the sensing devices provided by vendors, and consumers don't know whether the determining results are true or not. Thus, it is difficult for the security labels to become popular. Moreover, the security labels may be compromised by the unworthy vendors, and the unworthy vendors would use fake security labels and fake commodity to deceive consumers. Beside, the production of the security labels is complicated; the special sensing device is expensive, so the security labels are always used with high-price commodities (such as wine, jewelry, or artwork, etc) instead of livelihood commodities.

Therefore, how to design an effective security method to be used on popular commodities is worthy considering to the person having ordinary skills in the art.

### SUMMARY OF THE INVENTION

One object of the present invention is to provide a mobile security system. The mobile security system includes a wireless inductive tag (such as NFC tag) and a mobile electronic device. A code is saved in the wireless inductive tag, and the code is derived from commodity information via encryption. The mobile electronic device includes a wireless communication unit, an application program, and a display screen. The application program is configured to read and decipher the code of the wireless inductive tag. Then, the commodity information derived from the code via deciphering is displayed on the display screen, and the user can browse the commodity information. Therefore, because of the mobile security system, a consumer can compare the commodity with the information of the wireless inductive tag to identify whether they match or not.

The present invention uses handheld devices with short-range wireless communication technology instead of traditional RFID technology such as NFC or Bluetooth devices. The mobile electronic device using short-range wireless communication technology is popularity now, and an user can download the special mobile application program (APP) so as to identify the commodity information of the wireless inductive tag. It is helpful to popularize the security system of the present invention, and the security system can be used on all commodities including high-price commodities.

Furthermore, the mobile security system of the present invention further can integrate the commodity information into a cloud database. The commodity information can be synchronized with the cloud database via the internet function of the mobile electronic device when the wireless inductive tag is identified. The used wireless inductive tag would be tracked and marked so as to avoid counterfeiting.

### BRIEF DESCRIPTION OF THE DRAWINGS

FIG. 1 shows a block diagram of a mobile security system of the present invention.

FIG. 2 shows a mobile security system according to another embodiment.

FIG. 3 shows an application of the mobile security system and a security label according to another embodiment.

FIG. 4 shows a flow diagram of the security method using the mobile security system according to the present invention.

FIG. 5 shows a block diagram of the cloud database.

FIG. 6 shows a detailed flow diagram for the MRP input unit.

### DESCRIPTION OF THE PREFERRED EMBODIMENTS

In order to explain the present invention clearly, the exemplary wireless communication unit is a NFC unit in the following embodiment. However, other wireless transmission technologies such as Bluetooth are also covered in present invention.

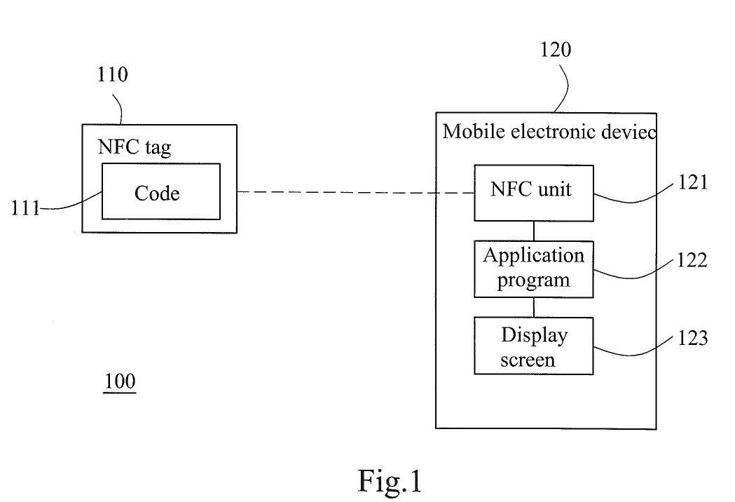

Please refer FIG. 1. FIG. 1 shows a block diagram of the mobile security system 100 of the present invention. The mobile security system 100 is configured to identify a status of a commodity by using the mobile electronic device to browse the commodity information. The mobile security system 100 includes a wireless inductive tag such as Bluetooth or NFC tag 110 and a mobile electronic device 120. The NFC tag 110 is adhered to the commodity, for example: adhered on package, cap, body, or other portions of the commodity. A code 111 is saved in the NFC tag 110, and the code 111 is derived from commodity information via encryption. Thus, the code 111 can be reverted to the commodity information only by a special application program. The commodity information is the production resumes of the commodity, for example: commodity title, manufacturing factory, certificate of origin, ingredient, content, manufacturing date, storage life, using method, notice, warning slogan or a combination thereof. The mobile electronic device 120 for example is a smart phone or a tablet PC, and the mobile electronic device 120 includes a wireless communication unit such as a Bluetooth or NFC unit 121, an application program 122, and a display screen 123. The NFC unit 121 is a NFC module disposed in the mobile electronic device 120 and enables the mobile electronic device 120 to receive wireless signals conforming the specification of Near Field Communication (NFC) and/or to read the information of the NFC tag 110. Therefore, the application program 122 can read the information and the code 111 of the NFC tag 110 via the NFC unit 121 of the mobile electronic device 120, and the code 111 would be deciphered. The commodity information reverted from the code 111 can be displayed on the display screen and read by a user. Thus, if the user finds a mismatch between the commodity information and the label disposed on the commodity, the user would know the NFC tag 110 is reused or misused, and the commodity may be a fake. For example: after the consumer uses the application program 122 to read the NFC tag 110, the commodity information displayed on the display screen 123 directs to a drink. However, the NFC tag 110 is adhered to bread. Thus, the consumer can know the NFC tag 110 is reused from drink, and the bread may be an expired recovered commodity pretending to be fresh.

Beside, the application program 122 can determine the status of the commodity based on the commodity information. For example: the application program 122 can read the current date via the mobile electronic device 120, and the application program 122 would read the manufacturing date and storage life of the commodity information. Then, the application program 122 compares the current date with the manufacturing date and storage life, and the comparing result would be displayed on the display screen 123 showing the remaining storage life or “overdue” slogan.

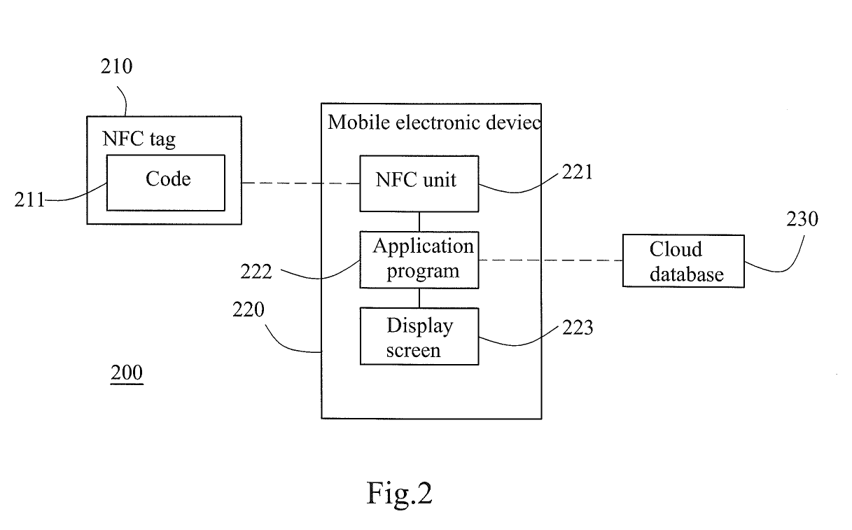

Please refer FIG. 2. FIG. 2 shows another embodiment of the mobile security system 200. The mobile security system 200 is configured to identify a status of a commodity by using the mobile electronic device to browse the commodity information. The mobile security system 200 includes a wireless inductive tag such as Bluetooth or NFC tag 210, a mobile electronic device 220 and a cloud database 230. In this embodiment, multiple pieces of first commodity information are saved in the cloud database 230. The first commodity information is the production resume of the commodity, for example: commodity title, manufacturing factory, certificate of origin, ingredient, content, manufacturing date, storage life, using method, notice, warning slogan or a combination thereof Furthermore, each first commodity information corresponds to a serial number. The NFC tag 210 is adhered to the commodity, for example: adhered on package, cap, body, or other portions of the commodity. A code 211 is saved in the NFC tag 210, and the code 211 is derived from the second commodity information and the serial number of the commodity via encryption. Thus, the code 211 can be deciphered only by a special application program. The mobile electronic device 220 such as a smart phone or a tablet PC has internet function and the mobile electronic device 220 includes a wireless communication unit such as a Bluetooth or NFC unit 221, an application program 222, and a display screen 223. The NFC unit 221 is a NFC module disposed in the mobile electronic device 220 and enables the mobile electronic device 220 to receive wireless signals conforming the specification of Near Field Communication (NFC) and/or to read the information of the NFC tag 210. Therefore, the application program 222 can read the information and the code 211 of the NFC tag 210 via the NFC unit 221 of the mobile electronic device 220, and the code 211 would be deciphered. After the code 211 is reverted to the second commodity information and the serial number, the application program 222 downloads the first commodity information corresponding to the serial number via the internet function of the mobile electronic device 220. Then, the application program 222 compares the first commodity information with the second commodity information. If the first commodity information matches the second commodity information, the application program 222 would display the first commodity information or the second commodity information on the display screen 223. If there is a mismatch between the first commodity information and the second commodity information, it represents the contents in the NFC tag 210 may be tampered. Therefore, the application program 222 transmits a signal to the cloud database 230. At the same time, the first commodity information is marked abnormal, and a warning massage is transmitted to the application program 222 for noticing consumer.

In addition, the application program 222 further can determine whether the commodity is abnormal or not besides comparing the first commodity information with the second commodity information. For example: the application program 222 can read the current date via the mobile electronic device 220. Thus, the application program 222 can calculate the manufacturing date and storage life of the commodity via comparing the first commodity information with the second commodity information. The application program 222 also can notify the consumer of commodity overdue and transmit a signal to the cloud database 230. The first commodity information in the cloud database 230 would be marked abnormal when the cloud database 230 receives the signal. Furthermore, the application program 222 also can read the location information via the GPS element of the mobile electronic device 220 to identify the current location of the commodity. For example, a commodity is only sold in a specific store, and the consumer uses the application program 222 to read the NFC tag 210 of the commodity. If the location of the commodity is too far away from the location recorded in the NFC tag 210, the mobile security system 200 identify the commodity may be swag or the NFC tag 210 may be reused. Therefore, the consumer can understand the status of commodity to identify whether the commodity is a fake or not because of the mobile security system 200 in the present invention.

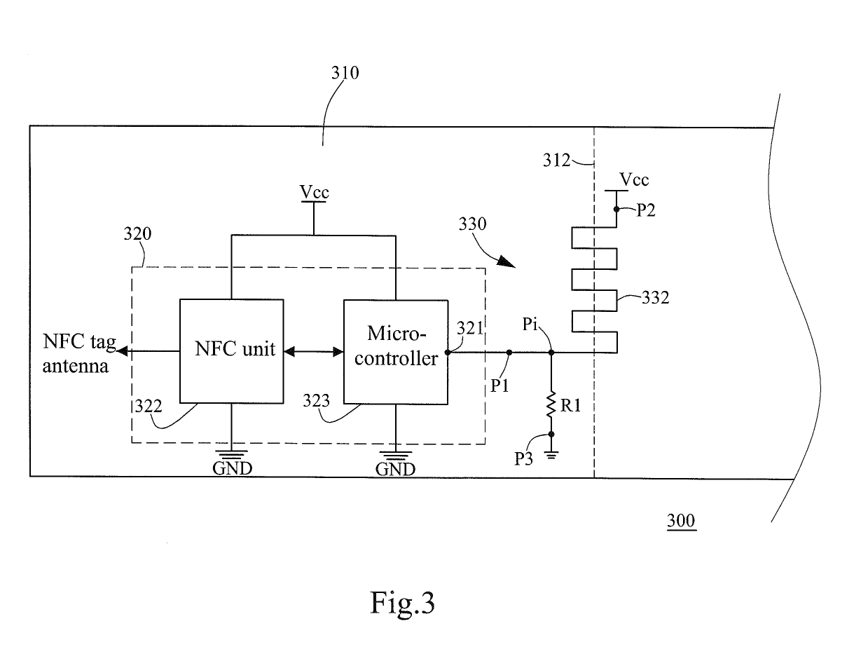

Please refer FIG. 3. FIG. 3 shows another embodiment of the present invention about an application of the mobile security system and a security label 300. Taiwan patent application No. 102147049 discloses a security label 300, and the security label 300 also can be applied with the mobile security system of the present invention. The security label 300 includes a substrate 310, a signal processor 320, and an extending circuit 330. The substrate 310 has a tear line 312 thereon. The tear line 312 for example is formed by a plurality of holes arrayed equidistant. The signal processor 320 is disposed on the substrate 310. The signal processor 320 is capable of receiving an electromagnetic wave and converting the electromagnetic wave into a DC voltage to supply energy for the operation of the signal processor 320. In this embodiment, the frequency of the electromagnetic wave is between 3 MHz and 30 MHz, but it can also be set in other frequency. The extending circuit 330 is also disposed on the substrate 310 and comprises a plurality of bends 332.

The extending circuit 330 further includes a first terminal P1, a second terminal P2, a third terminal P3, and an inner terminal Pi. The inner terminal Pi is connected to the first terminal P1, the second terminal P2, and the third terminal P3. The first terminal P1 is also connected to one of the input terminals 321 of the signal processor 320. The input terminal 321 for example is a general purpose I/O (GPIO) terminal of the signal processor 320. The second terminal P2 is also connected to a DC voltage source Vcc. The DC voltage source Vcc is produced when the signal processor 320 receives the electromagnetic wave. The third terminal P3 is connected to ground (i.e. grounding). In additional, the first resistor R1 is disposed on the extending circuit 330. The first resistor R1 and the signal processor 320 are connected to the inner terminal Pi in parallel. The inner terminal Pi is connected to the third terminal P3 via the first resistor R1. In this embodiment, the tear line 112 on the substrate 110 spans between the inner terminal Pi and the second terminal P2.

The signal processor 320 includes a NFC tag 322 and a microcontroller 323. The NFC tag 322 and the microcontroller 323 are connected to each other. The NFC tag 322 includes a NFC control circuit connected to a NFC antenna (not drawn in the figure). The microcontroller 323 is connected to the input terminal 321. The NFC tag 322 and the microcontroller 323 are further connected to a DC voltage source Vcc. A code is saved in the NFC tag 322, and the code is derived from the commodity information and commodity serial number via encryption.

In an ordinary situation, the tear line 312 is not torn. The consumer can use a mobile electronic device 220 having a NFC unit 221 and an application program 222 to read the NFC tag 322. At this moment, the electrical potentials of the first terminal P1, inner terminal Pi, and second terminal P2 are same. The electrical potentials of the third terminal P3 is lower than the first terminal P1, inner terminal Pi, and second terminal P2. When the microcontroller 323 detects the electrical potential of the first terminal P1 is higher than the one of the third terminal P3, the status of the bit of the microcontroller 323 is not changed. Therefore, a no abnormal massage and the commodity information would be displayed on the display screen 223 of the mobile electronic device 220, and the consumer can read the massage and the commodity information. On the contrary, the tear line 312 is torn, and the consumer uses a mobile electronic device 220 having NFC unit 221 and application program 222 to read the NFC tag 322. At this moment, the electrical potentials of the first terminal P1, inner terminal Pi, and second terminal P2 are same. When the microcontroller 323 detects the electrical potential of the input terminal 321 is changed, the status of the bit of the microcontroller 323 is reversed. The reversed bit can't be reversed again or is hardly to be reversed again. The “hardly to be reversed again” means it needs inputting a password (for example: 128 bit encryption key) so as to reverse the bit. Thus, even though the tear line 312 is remade, the status of the bit of the microcontroller 323 is still reversed. The application program 222 of the mobile electronic device 220 detects the status of the bit of the microcontroller 323 is reversed, so a warning massage would be displayed on the display screen 223. The consumer can know the security label 300 have torn or remade, so the commodity may be a fake. Beside, the identifying result would be transmitted to the cloud database 230 by the application program 222 via the Internet function of the mobile electronic device 220. The information of the cloud database 230 would be update when the cloud database 230 receives the identifying result, and the torn security label 300 is marked used. If the torn security label 300 is still used, the cloud database 230 would issue warning message to disclose the counterfeit.

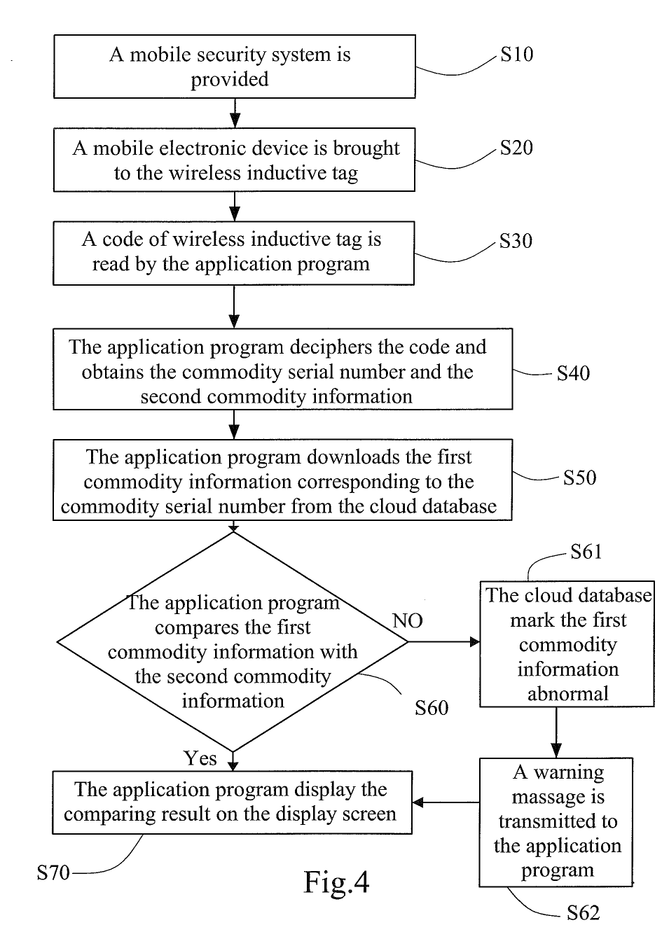

Please refer FIG. 4. FIG. 4 shows a flow diagram of the security method using the mobile security system. First, a mobile security system is provided (step S10). Then, a mobile electronic device having a wireless communication unit and an application program is brought to the wireless inductive tag (step S20). At this moment, a code of wireless inductive tag is read by the application program via the wireless communication of the mobile electronic device (step S30). Next, the application program deciphers the code of wireless inductive tag and obtains the commodity serial number and the second commodity information (step S40). Then, the application program would download the first commodity information corresponding to the commodity serial number from the cloud database (step S50). Next, the application program compares the first commodity information with the second commodity information (step S60). If the first commodity information matches with the second commodity information, the application program would display the comparing result on the display screen of the mobile electronic device (step S70). If there is a mismatch or abnormal between the first commodity information and the second commodity information, the cloud database would mark the first commodity information abnormal (step S61), and a warning massage is transmitted to the application program (step S62). Then, the warning massage and the comparing result are displayed on the display screen of the mobile electronic device (step S70).

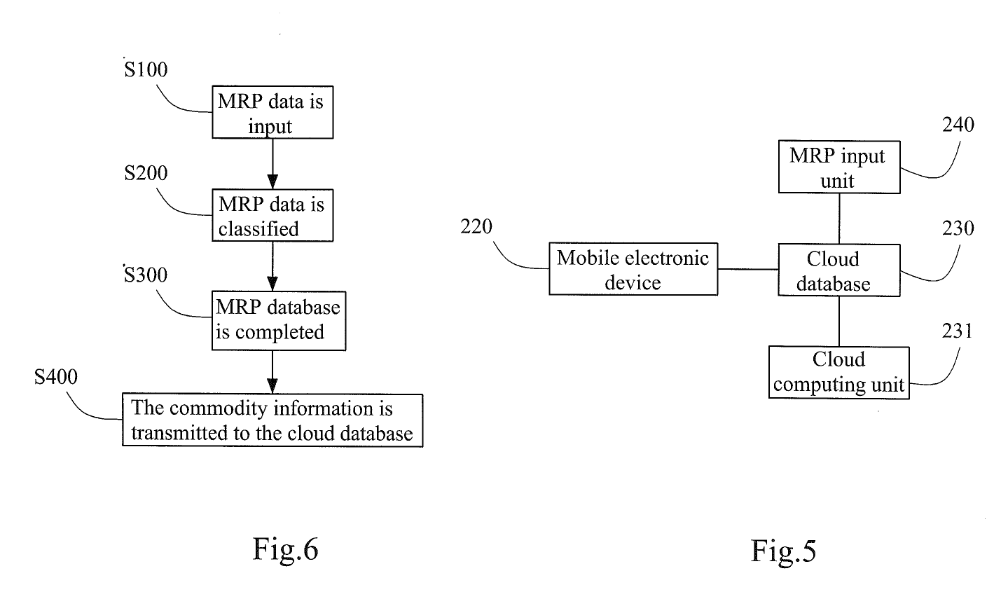

Please refer FIG. 5. FIG. 5 shows a block diagram of the cloud database 230. In above-embodiment, the second commodity information and the commodity serial are obtained by using the mobile electronic device 220 to read the code of the NFC tag 210, and the first commodity information is downloaded from the cloud database 230 to compare with the second commodity information. Therefore, the cloud database 230 further includes a cloud computing unit 231. The cloud computing unit 231 is configured to modify data or issue warning message. Beside, the cloud database 230 further includes a MRP input unit 240. MRP is Material Requirement Planning including commodity title, manufacturing factory, certificate of origin, ingredient, content, manufacturing date, storage life, using method, notice, warning slogan, etc.

Please refer FIG. 6. FIG. 6 shows a detailed flow diagram of the MRP input unit 240. The MRP input unit 240 is configured to receive a MRP data input by a commodity vendor so as to build a plurality of first commodity information. After the MRP data is input (step S100), the MRP data is classified (step S200), and the MRP database is completed (step S300). Then, the commodity information is transmitted to the cloud database 230 (step S400) so as to build a plurality of first commodity information in the cloud database 230.

The mobile security system of the present invention uses the wireless communication technology built in the mobile electronic device instead of traditional RFID technology because the NFC technology described in above-embodiment is becoming popular in modern society. Consumers can download the special NFC application program and launch the NFC function of the mobile electronic device so as to read and identify the commodity information in the NFC tag. The consumer doesn't need any cost during the reading and identifying. Furthermore, the commodity information is saved in the cloud database, so the commodity information is hardly tampered. Therefore, the mobile security system of the present invention provides a most economic security method to protect consumers.

Those skilled in the art will readily observe that numerous modifications and alternatives of the device and method may be made while retaining the teachings of the invention. Accordingly, the above disclosure should be construed as limited only by the meters and bounds of the appended claims. While the preferred embodiment of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

I claim:

1. A security system using a mobile electronic device configured to identify a commodity, the mobile security system comprising:
a wireless inductive tag adhered to the commodity and configured to save a code, wherein the code is derived from an commodity information of the commodity via encryption; and
a mobile electronic device, comprising:
a wireless communication unit;
an application program configured to read the code of the wireless inductive tag via the wireless communication unit and to decipher the code;
a display screen configured to display the commodity information deciphered from the code by the application program.

2. The mobile security system of claim 1, wherein the mobile electronic device is a smart phone or a tablet PC.

3. The mobile security system of claim 1, wherein the commodity information is a commodity title, a manufacturing factory, a certificate of origin, an ingredient, a content, a manufacturing date, a storage life, an using method, a notice, or a warning slogan, or a combination thereof.

4. The mobile security system of claim 1, wherein the application program is further configured to determine a status of the commodity based on the commodity information.

5. The mobile security system of claim 1, wherein the wireless communication unit is a Bluetooth or a NFC unit.

6. The mobile security system of claim 1, wherein the wireless inductive tag is a Bluetooth or a NFC tag.

7. A security system using a mobile electronic device configured to identify a commodity, the mobile security system comprising:
a cloud database configured to save a plurality of first commodity information, each first commodity information corresponding to a serial number;
a wireless inductive tag adhered to the commodity and configured to save a code, the code being derived from the serial number and a second commodity information by encryption; and
a mobile electronic device, comprising:
a wireless communication unit;
an application program configured to read the code of the wireless inductive tag via the wireless communication unit, to decipher the code, to download the first commodity information corresponding to the serial number from the cloud database, and to compare the first commodity information with the second commodity information; and
a display screen configured to display a comparing result from the application program.

8. The mobile security system of claim 7, wherein when there is a mismatch between the first commodity information and the second commodity information, the first commodity information is marked abnormal and a warning massage is transmitted to the application program.

9. The mobile security system of claim 7, wherein the mobile electronic device is a smart phone or a tablet PC.

10. The mobile security system of claim 7, wherein the first commodity information and second commodity are a commodity title, a manufacturing factory, a certificate of origin, an ingredient, a content, a manufacturing date, a storage life, an using method, a notice or a warning slogan.

11. The mobile security system of claim 7, wherein the wireless communication unit is a Bluetooth or a NFC unit.

12. The mobile security system of claim 7, wherein the wireless inductive tag is a Bluetooth or a NFC tag.

13. A security method using the mobile electronic device, comprising:
A. providing a mobile security system of claim 7;
B. bringing the mobile electronic device to the wireless inductive tag;
C. reading the code of the wireless inductive tag by the application program via the wireless communication unit;
D. deciphering the code and obtaining the serial number and the second commodity information by the application program;
E. downloading the first commodity information corresponding to the serial number from the cloud database by the application program;
F. comparing the first commodity information with the second commodity information by the application program;
G displaying the comparing result on the display screen.

14. The security method using the mobile electronic device of claim 13, wherein if there is a mismatch between the first commodity information and the second commodity information, the following step is carried out: H. marking the first commodity information abnormal and transmitting a warning massage to the application program by the cloud database.
